(19) United States
(12) Patent Application Publication
(10) Pub. No.: US 2012/0066265 A1
(43) Pub. Date: Mar. 15, 2012

(54) Method and Apparatus for Supporting Multiple Users Working on a Project

(75) Inventors: Yufeng Li, Wynnewood, PA (US); Joe Najjar, Pepperell, MA (US)

(73) Assignee: Siemens Corporation, Iselin, NJ (US)

(21) Appl. No.: 13/226,804

(22) Filed: Sep. 7, 2011

Related U.S. Application Data
(60) Provisional application No. 61/381,546, filed on Sep. 10, 2010.

(51) Int. Cl. G06F 17/30

(52) U.S. Cl. 707/792; 707/E17.055

(57) ABSTRACT

A method, apparatus, and computer-readable medium for supporting multiple users working on a project includes a project server. Projects are divided into a plurality of revision units based on the type of each of the plurality of objects and the relationships between the plurality of objects. The division of the project into a plurality of revision units can be facilitated by determining that an object type of an object is included in a user defined list of objects to be designated root objects of a revision unit. Objects having an object type not included in the user defined list of objects to be designated as root objects are designated non-root objects and associated with a revision unit of a root object that the non-root object branches from. Projects divided into a plurality of revision units can be stored in a database in communication with the project server.

### CROSS REFERENCE TO RELATED APPLICATIONS

This application claims the benefit of U.S. Provisional Application No. 61/381,546 filed Sep. 10, 2010, which is incorporated herein by reference.

### FIELD OF THE DISCLOSURE

The present disclosure relates generally to project engineering, and more particularly to supporting multiple users working on a project.

### BACKGROUND

Engineering projects range in size and complexity. Engineering projects can pertain to anything from simple devices to a plant for manufacturing complex devices. Engineering projects can also pertain to different types of things such as electronic devices, clothing, software, manufacturing plants, etc.

Large engineering projects can be complex and require many different people to work on different aspects of the project while coordinating their efforts with each other. Thus, large engineering projects require many people to work together efficiently toward a common goal.

### SUMMARY

In one embodiment, a method for supporting multiple users working on a project comprises receiving a project at a project server. The project comprises a plurality of objects arranged in a hierarchy. The project server divides the project into a plurality of revision units based on a type of each of the plurality of objects and relationships between the plurality of objects.

In one embodiment, the objects can be divided by designating a first object as a root node of a particular revision unit in response to determining that the first object has an object type included in a user defined list of object types to be designated root objects. A second object can be associated with the particular revision unit in response to determining that the second object is an object type not included in the user defined list of object types to be designated root objects and the second object branches from the first object. The second object can branch directly from the first object. The second object can alternatively branch from the first object via an intermediate (also referred to as interceding) object. In one embodiment, the plurality of objects are divided into a plurality of revision units by classifying each of a plurality of objects as one of root objects and non-root objects, designating each root object as a root node of a separate revision unit, and assigning each non-root object to a revision unit of a root object from which the non-root object branches directly or via an interceding non-root object. The project can be stored in a project database of the project server and can comprise a plurality of datasets with each of the datasets associated with a respective one of the plurality of revision units. A copy of the project can be transmitted to a user in response to receiving a check out request from the user. Revision units associated with a particular user can be locked in response to the particular user checking out the revision unit. The project server can receive a modified revision unit of the project from a user and update the project stored in the database of the project server in response to receiving the modified revision unit.

An apparatus for performing the above method and a computer-readable medium storing instructions for causing a computing device to perform operations similar to the above method are also disclosed.

These and other advantages of the invention will be apparent to those of ordinary skill in the art by reference to the following detailed description and the accompanying drawings.

### BRIEF DESCRIPTION OF THE DRAWINGS

FIG. 1 depicts a project having a hierarchical structure;

FIG. 2 depicts a diagram of a network according to one embodiment;

FIG. 3 depicts a project divided into multiple revision units;

FIG. 4 depicts a flowchart showing a method according to one embodiment;

FIG. 5 depicts a flowchart showing a method according to one embodiment; and

FIG. 6 depicts a high-level block diagram of a computer according to one embodiment.

### DETAILED DESCRIPTION

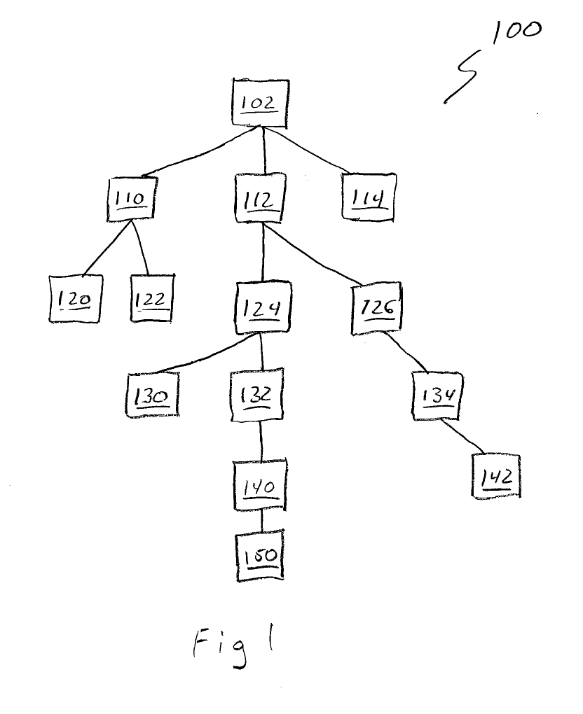

A project is a representation of an item, endeavor, design, etc. to be developed. FIG. 1 shows project 100 having a hierarchical (i.e., tree) structure including multiple nodes (i.e., nodes 102, 110, 112, 114, 120, etc.) and branches depicting relationships between the nodes. As shown in FIG. 1, root node 102 is depicted at the top of project 100 with branches and additional nodes (i.e., nodes 110, 112, 114, etc.) extending downward.

Project 100 of FIG. 1 is shown comprising 6 levels and 14 nodes, however, other projects may have more or less levels and nodes. The nodes (102, 110, 120, etc.) of project 100 each represent an object. An object can be, for example, a device, algorithm, machine, or component. Each object has an associated configuration file which defines the object including the type of the object (e.g., hardware, control algorithm, machine, component, etc.) and the relationships between the object and other objects in project 100.

Project 100, in one scenario, can be a manufacturing process which requires the addition of dry and liquid materials to a vat and subsequent mixing. In this scenario, object 102 is a master controller (e.g., a computer or CPU) configured to control the overall operation of project 100 and, more specifically, the addition of dry and liquid components to a vat (not shown) and subsequent mixing. Objects 110 and 112 branch from object 102. Object 110 is a controller (e.g. a computer, programmable logic controller (PLC), or CPU) configured to control the addition of dry materials to the vat. Object 112 is a CPU configured to control the addition of liquids to the vat. Object 114 branches from object 102 and represents a control algorithm used to control the overall operation of project 100 including the addition of dry and liquid materials to the vat and subsequent mixing.

Objects 120 and 122 are shown branching from object 110. Object 120 represents an algorithm for determining and controlling the amount of dry material A added to the vat. Object 122 represents an algorithm for determining and controlling the amount of dry material B added to the vat.

Object 124 is shown branching from object 112. Object 124 represents a controller configured to control the addition of liquid A and liquid B to the vat. Object 130 depends from object 124 and represents an algorithm for controlling the addition of liquid A to the vat. Object 132 depends from object 124 and represents an algorithm for controlling the addition of liquid B to the vat. Liquid B, in this example, is composed of two liquids, namely, liquid B1 and liquid B2. Object 140 branches from object 132 and represents an algorithm for controlling the amount of liquid B1 required for liquid B. Object 150 branches from object 140 and represents an algorithm for controlling the amount of liquid B2 required for liquid B.

Object 126 branches from object 112 and represents an algorithm to control the addition of liquid C to the vat. Liquid C, in this example, is required to be within a certain temperature range when added to the vat. Object 134 branches from object 126 and represents a controller for controlling the temperature of liquid C. Object 142 branches from object 134 and represents an algorithm for controlling the temperature of liquid C.

In one embodiment, projects can be created by a user and uploaded to a project server via a network. Projects can then be accessed by multiple users via the project server which acts as a repository for multiple projects.

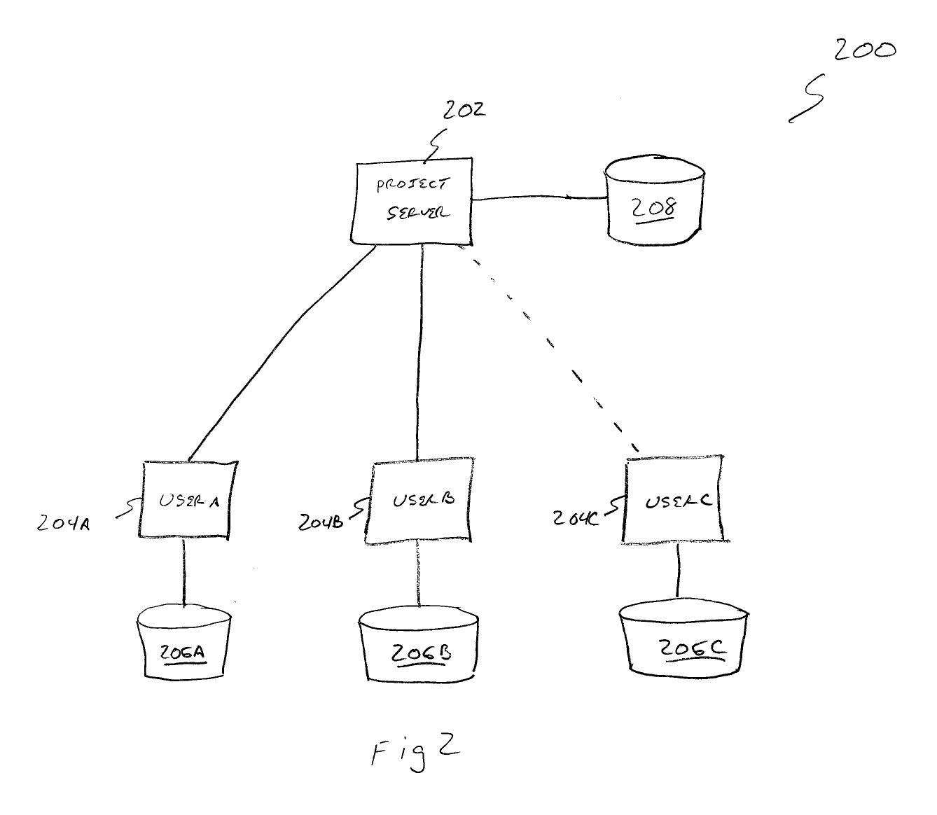

FIG. 2 depicts a network 200 including a project server 202 which can communicate with multiple devices associated with users including user device A 204A, user device B 204B, and user device C 204C. Project server 202 and user devices 204A, 204B, and 204C, in one embodiment, are computers that can communicate with each other via a network such as a local or wide area network. FIG. 2 shows user device A 204A and user device B 204B in communication with project server 202 while user device C 206C is shown capable of communicating with project server 202 but currently disconnected. Project server 202 is also in communication with database 208. Similarly, user devices 204A, 204B, and 204C are in communication with databases 206A, 206B, and 206C respectively. Databases 206A, 206B, 206C, and 208 are configured to store projects, such as project 100. Project 100, in one embodiment, can be generated by a user locally and subsequently uploaded to project server 202 for analysis and division into multiple revision units.

Project 100, in one embodiment, is created by a user using a graphical user interface. A user can select an object, define the type of the object and the specifics of the object. For example, a user can select an object and identify the object as a controller (e.g. programmable logic unit) and define the specifications of the controller (i.e., a user can enter the actual specifications of the controller or enter the make and model of the controller to have the controller specifications entered automatically). A user can also select an object and identify the object as an algorithm, define the specifications of the algorithm, and define the algorithm. Similarly, additional objects can be selected, identified, and provided with specifications by a user. Additional types of objects can be user defined. Information pertaining to an object is stored in a configuration file associated with the object. A user can define the relationships between objects by connecting objects with branches. For example, a controller and an algorithm to be executed by the controller can each be represented by objects selected and defined by the user. The user can then connect the controller object and algorithm object using a branch. Information pertaining to relationships between objects is also stored in the configuration file.

Project 100 is divided into smaller portions referred to as revision units in order to allow multiple users to work on the project separately and/or in parallel. Division of project 100 into revision units also allows a particular user to work on a particular portion of project 100. A revision unit can be a partial sub-tree within the parent/child structure of project 100. A revision unit needs to be small enough to allow multiple users such as coworkers to work in parallel but large enough to be efficient. The granularity of revision units can be user defined. A particular revision unit and the number of objects included in the particular revision unit can be based on rules. In one embodiment, a user defined rule specifies that certain object types specified by a user in a configuration file should be designated root objects and other object types should be designated non-root objects.

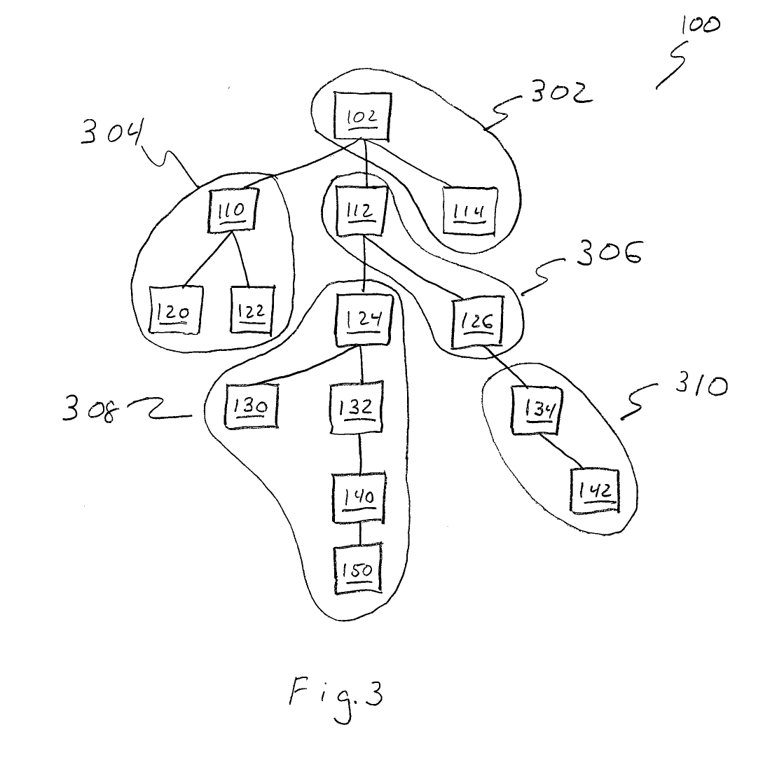

FIG. 3 depicts project 100 divided into multiple revision units according to one embodiment. In this embodiment, a rule is applied in which each object is compared to a user defined list of object types that should be designated root objects. The user defined list of objects that should be designated as root-type objects is, in one embodiment, stored in a configuration file. An additional rule is also applied in which objects having a type not included in the user defined list and branching from a root object are included in the revision unit associated with the root object. For example, object 102 is determined to be (or classified as) a root object (i.e., an object having a type that is included in the user defined list of object types that should be designated root objects) for project 100 and is thus considered (or designated as) a root object of a revision unit, in this embodiment, revision unit 302. Objects branching from object 102 (i.e., 110, 112, and 114) are then considered to determine if they will be included in (or assigned to) revision unit 302. Objects 110 and 112 are determined to have an object type included in the user defined list and are therefore designated root nodes for additional (separate) revision units and not included in revision unit 302. Object 114 is determined to be an object type not included in the user defined list and, as such, object 114 is included in revision unit 302.

Object 110 is determined to be an object type included in the user defined list and therefore object 110 is designated as a root object of a revision unit, in this example, revision unit 304. Objects 120 and 122 branch from object 110 and are determined to be non-root objects. Since objects 120 and 122 are determined to be non-root objects these objects are included in revision unit 304. Thus, revision unit 304 comprises objects 110, 120, and 122.

Object 112 is determined to be an object type included in the user defined list and thus a root node of revision unit 306. Object 124 branches from object 112 and is determined to be an object type included in the user defined list and is therefore not included in revision unit 306. Object 126 is determined to be an object type not included in the user defined list and is therefore designated a non-root type object and is included in revision unit 306. Object 134 branches from object 126 and is determined to be an object type included in the user defined list and therefore a root object and, as such, object 126 is not included in revision unit 306.

Object 124, as described above, is determined to be an object type included in the user defined list and is therefore designated the root node of revision unit 308. Objects 130 and 132 branching from object 124, and objects 132, 140, and 150 branching sequentially from object 124, are all determined to be object types not included in the user defined list and therefore are designated as non-root objects and included in revision unit 308. It should be noted that, in one embodiment, a non-root object is assigned to a revision unit of a root object from which the non-root object branches from directly or via an interceding non-root object.

Object 142, branching from object 134, is determined to be an object type not included in the user defined list and therefore designated a non-root object and is included in revision unit 310.

As described above, each of the plurality of objects that make up project 100 are analyzed to determine (also referred to as classifying) their object type and relationship to other objects in order to divide project 100 into revision units (e.g., revision units 302, 304, 306, etc.).

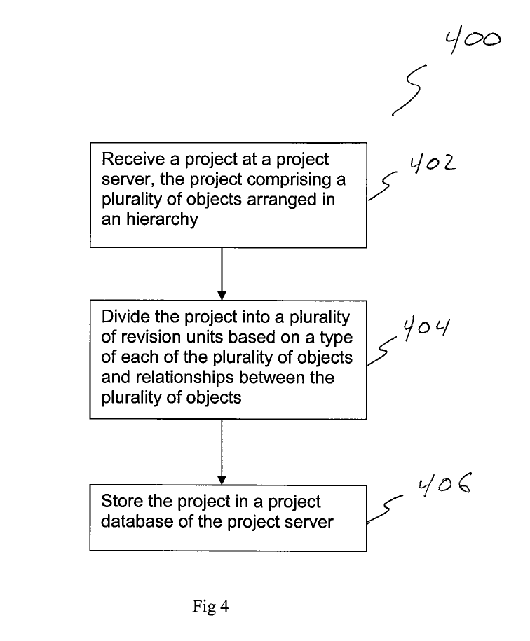

FIG. 4 depicts a method for dividing a project into revision units according to one embodiment. At step 402, a project is received by project server (e.g., project server 202 of FIG. 2). For example, a project can be received from one of user devices such as user device A 204A. At step 404, project server 202 divides the project into a plurality of revision units based on a type of each of the plurality of objects and the relationships between the objects. At step 406 the project is stored in a project database of the project server (e.g., database 208 of FIG. 2). In one embodiment, the division of a project into a plurality of revision units is performed locally by a user device, such as user device A 204A (shown in FIG. 2). A project divided into a plurality of revision units can be uploaded to a project server (e.g. project server 202 of FIG. 2) after division as a plurality of files or data sets.

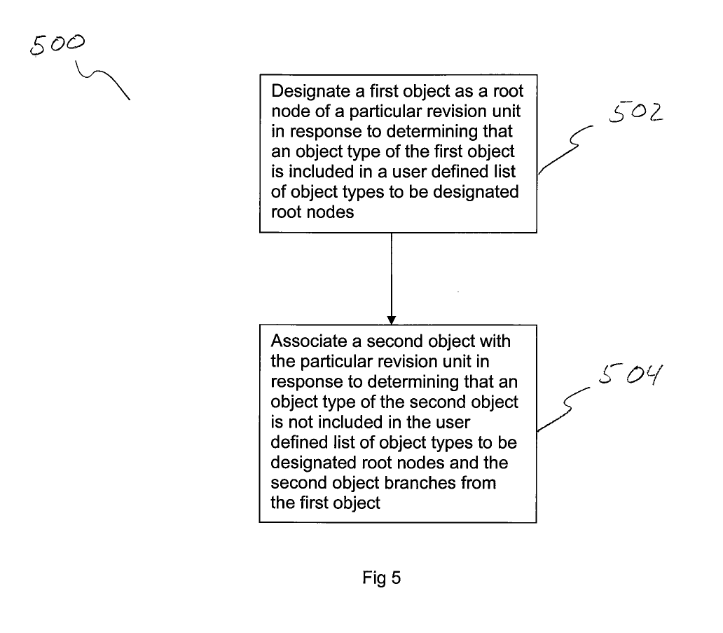

FIG. 5 depicts flow chart 500 showing details of step 404 shown in FIG. 4 according to one embodiment. As illustrated in FIG. 5, at step 502, project server 202 (shown in FIG. 2) designates a first object as a root node of a particular revision unit in response to determining that the first object is an object type included in a user defined list of objects that should be designated root objects. At step 504, project server 202 associates a second object with the particular revision unit in response to determining that the second object is an object type not included in the user defined list and is designated a non-root object and branches from the first object. It should be noted that, in one embodiment, a project could be received at a user device, such as user device A 204A, and divided into a plurality of revision units. The plurality of revision units can then be transmitted to a project server, such as project server 202.

The steps shown in flow chart 500 are repeated for each node (i.e., object) included in a particular project. In one embodiment, the nodes are analyzed starting from the top most node (root node) of a project and the analysis of nodes continues downward to lower nodes branching from an upper node. As described above, in one embodiment, a rule indicating that objects having a type that is included in a user defined list of objects that should be designated root objects are designated as root nodes and non-root objects branching from root objects should be included in a particular revision unit with the root object. It should be noted that a user can further divide a project into additional revision units using a graphical interface. Other rules, such as rules to designate revision units based on function, may be used in conjunction with or in place of the rules previously described. In addition, a user can also override rules to change how a particular project is divided into revision units. For example, a user can manually designate objects to be included in particular revision unit.

It should be noted that an object can branch directly from another object (e.g., object 110 branches directly from object 102 as shown in FIG. 1). An object can also branch from another object via one or more intermediate objects. For example, object 132 is considered to branch directly from object 124 as shown in FIG. 1. Object 132 is also considered to branch from object 112 via intermediate object 124. Object 132 is also considered to branch from object 102 via intermediate objects 124 and 112.

After a project is divided into revision units, information pertaining to each revision unit is serialized and exported to a file which can be referenced to identify objects associated with a particular revision unit. The files pertaining to the revision units are stored with the associated project.

Returning to FIG. 2, projects, such as project 100, can be created locally on a user's device such as user device A 204A using a graphical user interface. Projects created on a user's device can be stored locally on a user device or in a database associated with a user device such as database 206A. A user can upload a project to project server 202 for analysis and division into revision units as previously described. Projects uploaded to project server 202 can be stored in database 208 associated with project server 202. Project server 202, in one embodiment, controls the viewing, distribution, and updating of projects.

Projects uploaded to server 202 contain user defined information pertaining to access rules. For example, a user can define which users are authorized to access a particular project. Additional access rules can also be defined identifying users who are authorized to modify projects. Access rules, in one embodiment, identify users authorized to access and/or modify particular revision units of a particular project.

Users can view a listing of projects stored by project server 202 by transmitting a request to project server 202. The list of projects presented to a user can be restricted based on access rules. In one embodiment, the list of projects presented to a user contains additional information identifying particular users associated with the project. For example, the listing can identify the revision units of a particular project as well as the users identified as associated with each of the revision units (i.e., users who are authorized to access and/or modify revision units)

In one embodiment, users can create a local view of projects stored by project server 202. To create a local view of a project, a user transmits a request to project server 202. In response to the request, project server 202 determines if the requesting user is authorized to receive a copy of the project. In response to determining that the requesting user is authorized to receive the project, a copy of the project is transmitted to the user device associated with the requesting user. In one embodiment, the copy of the project transmitted to the user includes changes made to the project prior to the user's request. However, a user can request prior versions of a project as well. The transmitting of copies of projects for use a local user view can be restricted based on access rules. In one embodiment, a particular user can request a project and, in response, a copy of the project stored in database 208 is downloaded to a user device associated with the particular user. This allows a user to access and/or work on a project remotely, when the user is not in communication with project server. For example, user device 204C is shown capable of communicating with project server 202 but currently disconnected. A project can be downloaded to user device 204C thereby allowing user C to work on the downloaded project despite being disconnected from project sever 202.

A user can access and modify a local copy of a project after it is downloaded from a project server. In one embodiment, a user can modify revision units of a local project for which the user is authorized. This allows users to work on (i.e., create, modify, test, etc.) objects of revision units of a project. After modification of revision units of a project, the user can upload the modified project to project server 202. Project server 202 then updates its copy of the project stored in database 208. This allows a user to modify and test revision units locally in order to verify that the modifications have the desired effect before uploading the modified project to a project server. A user can upload a copy of a project to a project server by transmitting an upload request to the project server. Similar to the process of requesting a copy a project, a user's authorization to upload a project may be determined prior to allowing the project to be uploaded and/or integrated into an existing project. In one embodiment, project server 202 identifies the revision units modified in the uploaded project and records this information in a file associated with the project. This information can be used to notify other users working on the project that revision units associated with the project have been modified. In one embodiment, a user accessing project server 202 and viewing a list of stored projects is provided with an indication that projects have been modified. Additional information, such as the identity of the user who modified the project, can be displayed as well. Notifications can also be generated and transmitted to users associated with a particular project in response to a determination that the project has been modified.

A user can also “check out” specific revision units by transmitting a request to a project server. Checking out a revision unit results in the checked out revision unit being locked by the project server in order to prevent multiple users from modifying a specific revision unit in parallel. A user can “check in” a previously checked out revision unit, usually after the revision unit has been modified, but modification is not necessary. Similar to requesting a view of a project as described above, access rules may be applied to prevent unauthorized users from checking out or checking in revision units.

The local view, checking in, and checking out methods described above facilitates multiple users working on a project. In order to prevent simultaneous modification of revision units by multiple users, as described above, particular revision units of a project may be “locked out” when the project is checked out by a user authorized to modify the particular revision units. More specifically, revision units that a user is authorized to modify are locked out meaning modification by other users is prevented. A user viewing a listing of projects stored by project server 202 can be provided with an indication of revision units locked out for a particular project. Revision units can be locked out to prevent modification by unauthorized users even though the project has not yet been downloaded by a user. For example, a user creating a project can designate a particular user as authorized to modify a particular revision unit. In this case, other users are prevented from modifying the particular revision unit regardless of whether the authorized user has downloaded (e.g., checked out) the project in which the particular revision unit is included.

As described above, project server 202 facilitates multiple users working on a particular project. It should be noted that the methods described above do not prevent a user from creating, storing, and modifying stand alone projects in which the project exists only on a user's device.

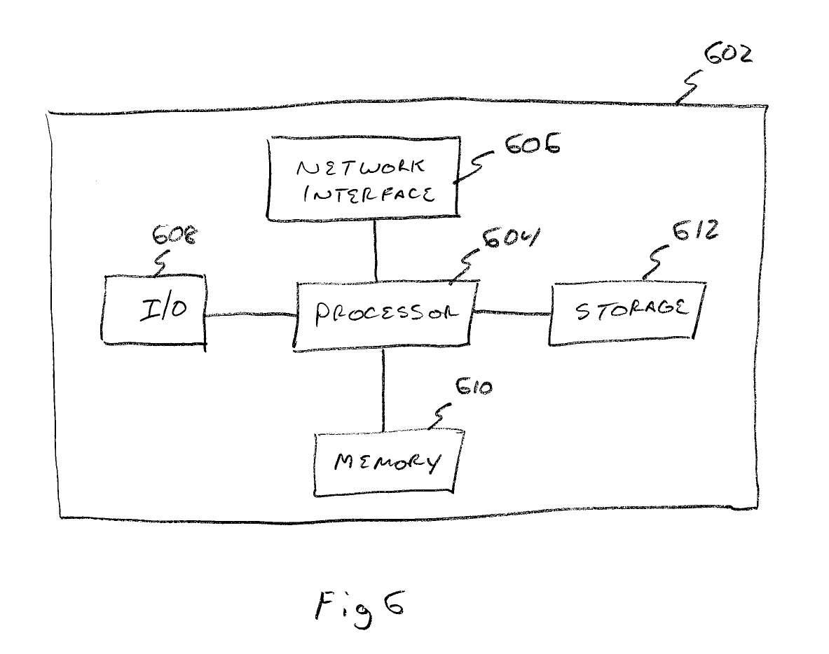

Project server 202, user device A 204A, user device B 204B, and user device C 204C and the methods depicted in FIGS. 4 and 5 may be implemented using a computer. A high-level block diagram of such a computer is illustrated in FIG. 6. Computer 602 contains a processor 604 which controls the overall operation of the computer 602 by executing computer program instructions which define such operation. The computer program instructions may be stored in a storage device 612, or other computer readable medium (e.g., magnetic disk, CD ROM, etc.), and loaded into memory 610 when execution of the computer program instructions is desired. Thus, the method steps of FIGS. 4 and 5 can be defined by the computer program instructions stored in the memory 610 and/or storage 612 and controlled by the processor 604 executing the computer program instructions. For example, the computer program instructions can be implemented as computer executable code programmed by one skilled in the art to perform an algorithm defined by the method steps of FIGS. 4 and 5. Accordingly, by executing the computer program instructions, the processor 604 executes an algorithm defined by the method steps of FIGS. 4 and 5. The computer 602 also includes one or more network interfaces 606 for communicating with other devices via a network. The computer 602 also includes input/output devices 608 that enable user interaction with the computer 602 (e.g., display, keyboard, mouse, speakers, buttons, etc.) One skilled in the art will recognize that an implementation of an actual computer could contain other components as well, and that FIG. 6 is a high level representation of some of the components of such a computer for illustrative purposes.

The foregoing Detailed Description is to be understood as being in every respect illustrative and exemplary, but not restrictive, and the scope of the inventive concept disclosed herein is not to be determined from the Detailed Description, but rather from the claims as interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A method for supporting multiple users working on a project, the method comprising:
receiving a project at a project server, the project comprising a plurality of objects arranged in a hierarchy; and
dividing the project into a plurality of revision units based on a type of each of the plurality of objects and relationships between the plurality of the objects.

2. The method of claim 1 wherein the dividing the project into a plurality of revision units comprises:
designating a first object as a root node of a particular revision unit in response to determining that an object type of the first object is included in a user defined list of object types to be designated root nodes.

3. The method of claim 2 wherein the dividing the project into a plurality of revision units further comprises:
associating a second object with the particular revision unit in response to determining that an object type of the second object is not included in the user defined list of object types to be designated root nodes and the second object branches from the first object.

4. The method of claim 3 wherein the second object branches directly from the first object.

5. The method of claim 3 wherein the second object branches from the first object via an intermediate object.

6. The method of claim 1 further comprising:
storing the project in a project database of the project server, the project comprising a plurality of datasets, each of the plurality of datasets associated with a respective one of the plurality of revision units; and
transmitting a copy of the project to a user in response to receiving a request from the user.

7. The method of claim 6 further comprising:
locking a revision unit associated with a particular user in response to the particular user checking out the revision unit.

8. The method of claim 1 further comprising:
receiving a modified revision unit of the project from a user; and
updating the project stored in the database of the project server in response to receiving the modified revision unit.

9. The method of claim 1 wherein the dividing the project into a plurality of revision units comprises:
classifying each of the plurality of objects as one of a root object and a non-root object;
designating each root object as a root node of a separate revision unit; and
assigning each non-root object to a revision unit of a root object from which the non-root object branches directly or via an interceding non-root object.

10. An apparatus for supporting multiple users working on a project, the apparatus comprising:
means for receiving a project at a project server, the project comprising a plurality of objects arranged in a hierarchy; and
means for dividing the project into a plurality of revision units based on a type of each of the plurality of objects and relationships between the plurality of the objects.

11. The apparatus of claim 10 wherein the means for dividing the project into a plurality of revision units comprises:
means for designating a first object as a root node of a particular revision unit in response to determining that an object type of the first object is included in a user defined list of object types to be designated root nodes.

12. The apparatus of claim 11 wherein the means for dividing the project into a plurality of revision units further comprises:
means for associating a second object with the particular revision unit in response to determining that an object type of the second object is not included in the user defined list of object types to be designated root nodes and the second object branches from the first object.

13. The apparatus of claim 12 wherein the second object branches directly from the first object.

14. The apparatus of claim 12 wherein the second object branches from the first object via an intermediate object.

15. The apparatus of claim 10 further comprising:
means for storing the project in a project database of the project server, the project comprising a plurality of datasets, each of the plurality of datasets associated with a respective one of the plurality of revision units; and
means for transmitting a copy of the project to a user in response to receiving a request from the user.

16. The apparatus of claim 15 further comprising:
means for locking a revision unit associated with a particular user in response to the particular user checking out the revision unit.

17. The apparatus of claim 10 further comprising:
means for receiving a modified revision unit of the project from a user; and
updating the project stored in the database of the project server in response to receiving the modified revision unit.

18. The apparatus of claim 10 wherein the means for dividing the project into a plurality of revision units comprises:
means for classifying each of the plurality of objects as one of a root object and a non-root object;
means for designating each root object as a root node of a separate revision unit; and
means for assigning each non-root object to a revision unit of a root object from which the non-root object branches directly or via an interceding non-root object.

19. A computer-readable medium having instructions stored thereon, the instructions for supporting multiple users working on a project, the instructions in response to execution by a computing device cause the computing device to perform operations comprising:
receiving a project at a project server, the project comprising a plurality of objects arranged in a hierarchy; and
dividing the project into a plurality of revision units based on a type of each of the plurality of objects and relationships between the plurality of the objects.

20. The computer-readable medium of claim 19 wherein the operation of dividing the project into a plurality of revision units comprises:
designating a first object as a root node of a particular revision unit in response to determining that an object type of the first object is included in a user defined list of object types to be designated root nodes.

21. The computer-readable medium of claim 20 wherein the operation of dividing the project into a plurality of revision units further comprises:
associating a second object with the particular revision unit in response to determining that an object type of the second object is not included in the user defined list of object types to be designated root nodes and the second object branches from the first object.

22. The computer-readable medium of claim 21 wherein the second object branches directly from the first object.

23. The computer-readable medium of claim 21 wherein the second object branches from the first object via an intermediate object.

24. The computer-readable medium of claim 19, the operations further comprising:
storing the project in a project database of the project server, the project comprising a plurality of datasets, each of the plurality of datasets associated with a respective one of the plurality of revision units; and
transmitting a copy of the project to a user in response to receiving a request from the user.

25. The computer-readable medium of claim 24, the operations further comprising:
locking a revision unit associated with a particular user in response to the particular user checking out the revision unit.

26. The computer-readable medium of claim 19, the operations further comprising:
receiving a modified revision unit of the project from a user; and
updating the project stored in the database of the project server in response to receiving the modified revision unit.

27. The computer-readable medium of claim 19 wherein the operation of dividing the project into a plurality of revision units comprises:
classifying each of the plurality of objects as one of a root object and a non-root object;
designating each root object as a root node of a separate revision unit; and
assigning each non-root object to a revision unit of a root object from which the non-root object branches directly or via an interceding non-root object.
